(19) United States
(12) Patent Application Publication
(10) Pub. No.: US 2006/0285702 A1
(43) Pub. Date: Dec. 21, 2006

(54) Multi-mode driver circuit

(76) Inventor: Matthew D. Felder, Austin, TX (US)

Correspondence Address: GARLICK HARRISON & MARKISON, P.O. BOX 160727, AUSTIN, TX, 78716-0727, US

(21) Appl. No.: 11/155,459

(22) Filed: Jun. 17, 2005

(51) Int. Cl. H04R 3/00

(52) U.S. Cl. 381/111

(57) ABSTRACT

A multi-mode driver circuit includes a first channel driver, a second channel driver, and a control module. The first channel driver module is operably coupled to drive a first channel signal to a first node of an output. The second channel driver module is operably coupled to drive a second channel signal to a second node of the output. The control module is operably coupled to provide a monotone signal as the first channel signal to the first channel driver module and an inversion of the monotone signal as the second channel signal to the second channel driver module when the multi-mode driver is in a first state. The control module is also operably coupled to provide a first stereo signal as the first channel signal to the first channel driver module and a second stereo signal as the second channel signal to the second channel driver module when the multi-mode driver is in a second state.

### BACKGROUND OF THE INVENTION

1. Technical Field of the Invention

This invention relates generally to audio processing and more particularly to driving audio signals onto different audible rendering loads.

2. Description of Related Art

Driver circuits are known in the audio processing art to provide sufficient power to drive an audible rendering load (e.g., headphones, speaker(s), line out connections, etc.). As is also known, there are a variety of driver circuit implementations based on the particular audible rendering load. For example, FIG. 1 is a schematic block diagram of a differential drive circuit that includes a differential source and a differential driver.

In this known embodiment, the differential source, which may be a digital to analog converter, microphone, line-in connection, etc., produces a differential representation of an audio signal. The differential driver provides the differential signal to input nodes of a speaker at a desired level.

FIG. 2 is a schematic block diagram of another known driver circuit that includes the differential source and a pair of single-ended drivers. The single-ended drivers provide the differential signal to the speaker at a desired level.

FIG. 3 is a schematic block diagram of yet another known driver circuit that includes a single-ended source, a non-inverting driver, and an inverting driver. In this driver, the single-ended source produces a single-ended representation of an audio signal. The non-inverting driver provides a non-inverted representation of the audio signal to a node of the speaker at a desired level. The inverting driver provides an inverted representation of the audio signal to a second node of the speaker at the desired level.

Each of the drive circuits of FIGS. 1-3 provide an adequate drive circuit for a monotone signal to speaker load, but are not adept at providing stereo signals to headphones or to stereo speakers. Further, drivers that are adept at providing stereo signals to headphones or to stereo speakers are not adept at providing monotone signals to a speaker load.

Therefore, a need exists for a multi-mode driver that is adept at driving monotone signals and stereo signals to various loads.

### BRIEF SUMMARY OF THE INVENTION

The multi-mode driver of the present invention substantially meets these needs and others. In one embodiment, a multi-mode driver circuit includes a first channel driver, a second channel driver, and a control module. The first channel driver module is operably coupled to drive a first channel signal to a first node of an output. The second channel driver module is operably coupled to drive a second channel signal to a second node of the output. The control module is operably coupled to provide a monotone signal as the first channel signal to the first channel driver module and an inversion of the monotone signal as the second channel signal to the second channel driver module when the multi-mode driver is in a first state. The control module is also operably coupled to provide a first stereo signal as the first channel signal to the first channel driver module and a second stereo signal as the second channel signal to the second channel driver module when the multi-mode driver is in a second state.

In another embodiment, a multi-mode driver circuit includes a first channel driver module, a second channel driver module, and a control module. The first channel driver module is operably coupled to drive a first channel signal to a first node of an output. The second channel driver module is operably coupled to drive a second channel signal to a second node of the output. The control module is operably coupled to detect coupling of a headphone jack to the first and second nodes of the output; when the coupling of the headphone jack to the first and second nodes of the output is detected, provide a first stereo signal as the first channel signal to the first channel driver module and a second stereo signal as the second channel signal to the second channel driver module; and when the coupling of the headphone jack to the first and second nodes of the output is not detected, provide a monotone signal as the first channel signal to the first channel driver module and an inversion of the monotone signal as the second channel signal to the second channel driver module.

In a further embodiment, a multi-mode driver circuit includes a first channel driver module, a second channel driver module, and a control module. The first channel driver module is operably coupled to drive a first channel signal to a first node of an output. The second channel driver module is operably coupled to drive a second channel signal to a second node of the output. The control module is operably coupled to receive a left channel signal and a right channel signal; determine whether the multi-mode driver circuit is in a first state or a second state; when the multi-mode driver circuit is in the first state: mix the left and right channel signals to produce a monotone signal; provide the monotone signal as the first channel signal to the first channel driver module and an inversion of the monotone signal as the second channel signal to the second channel driver module; and when the multi-mode driver circuit is in the second state, provide the left channel signal as the first channel signal to the first channel driver module and the right channel signal as the second channel signal to the second channel driver module.

In yet another embodiment, an audio processing integrated circuit includes a processing module, memory, and a multi-mode driver circuit. The memory is operably coupled to the processing module, wherein the memory at least temporarily stores operational instructions that cause the processing module to process digital audio signals. The multi-mode driver circuit includes: a first channel driver module operably coupled to drive a first channel signal to a first node of an output; and a second channel driver module operably coupled to drive a second channel signal to a second node of the output. The memory further at least temporarily stores operational instructions that cause the processing module to: provide a monotone signal as the first channel signal to the first channel driver module and an inversion of the monotone signal as the second channel signal to the second channel driver module when the multi-mode driver is in a first state; and provide a first stereo signal as the first channel signal to the first channel driver module and a second stereo signal as the second channel signal to the second channel driver module when the multi-mode driver is in a second state.

### BRIEF DESCRIPTION OF THE SEVERAL VIEWS OF THE DRAWINGS

FIG. 1 is a schematic block diagram of a prior art driver circuit;

FIG. 2 is a schematic block diagram of another prior art driver circuit;

FIG. 3 is a schematic block diagram of yet another prior art driver circuit;

FIG. 4 is a schematic block diagram of an audio processing integrated circuit in accordance with the present invention;

FIG. 5 is a schematic block diagram of an embodiment of a multi-mode driver in accordance with the present invention;

FIG. 6 is a schematic block diagram of another embodiment of a multi-mode driver in accordance with the present invention;

FIG. 7 is a schematic block diagram of yet another embodiment of a multi-mode driver in accordance with the present invention;

FIG. 8 is a schematic block diagram of a further embodiment of a multi-mode driver in accordance with the present invention; and

FIG. 9 is a schematic block diagram of a still further embodiment of a multi-mode driver in accordance with the present invention.

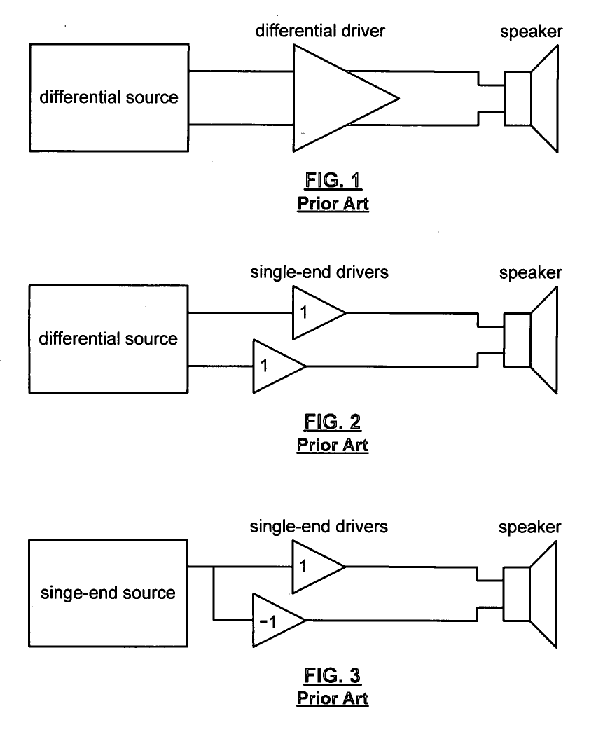

### DETAILED DESCRIPTION OF THE INVENTION

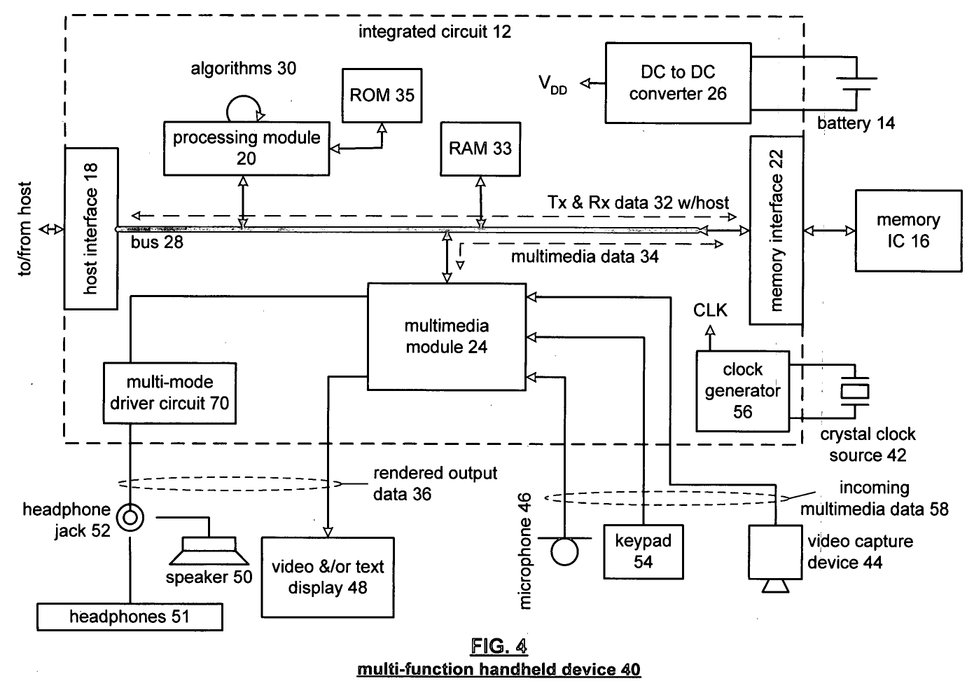

FIG. 4 is a schematic block diagram of a handheld device 40 that includes an integrated circuit 12, a battery 14, memory 16, a crystal clock source 42, one or more multimedia input devices (e.g., one or more video capture device(s) 44, keypad(s) 54, microphone(s) 46, etc.), and one or more multimedia output devices (e.g., one or more video and/or text display(s) 48, speaker(s) 50, headphone jack(s) 52, etc.). The integrated circuit 12 includes a host interface 18, a processing module 20, a memory interface 22, a multimedia module 24, a DC-to-DC converter 26, a multi-mode module 70, and a clock generator 56, which produces a clock signal (CLK) for use by the other modules. As one of average skill in the art will appreciate, the clock signal CLK may include multiple synchronized clock signals at varying rates for the various operations of the multi-function handheld device.

When the multi-function handheld device 40 is operably coupled to a host device, which may be a personal computer, workstation, server, a laptop computer, a personal digital assistant, and/or any other device that may transceive data with the multi-function handheld device, the processing module 20 performs at least one algorithm 30 where the corresponding operational instructions of the algorithm 30 are stored in memory 16, ROM 35, RAM 33, and/or other memory that may be included and/or coupled to the integrated circuit 12. The processing module 20 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 20 implements one or more of its functions via a state machine, analog circuitry, digital circuitry, and/or logic circuitry, the associated memory storing the corresponding operational instructions is embedded with the circuitry comprising the state machine, analog circuitry, digital circuitry, and/or logic circuitry.

When the multi-function handheld device 40 is in the first functional mode, the integrated circuit 12 facilitates the transfer of data between a host device and memory 16, which may be non-volatile memory (e.g., flash memory, disk memory, SDRAM) and/or volatile memory (e.g., DRAM). In one embodiment, the memory IC 16 is a NAND flash memory that stores both data and the operational instructions of at least a portion of one of the algorithms 30.

In this mode, the processing module 20 retrieves a first set of operational instructions (e.g., a file system algorithm, which is known in the art) from the memory 16 to coordinate the transfer of data. For example, data received from the host device (e.g., Rx data) is first received via the host interface module 18. Depending on the type of coupling between the host device and the handheld device 40, the received data will be formatted in a particular manner. For example, if the handheld device 40 is coupled to the host device via a USB cable, the received data will be in accordance with the format proscribed by the USB specification. The host interface module 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided, via the memory interface 22, to memory 16 for storage. In this mode, the handheld device 40 is functioning as extended memory of the host device (e.g., like a thumb drive).

In furtherance of the first functional mode, the host device may retrieve data (e.g., Tx data) from memory 16 as if the memory were part of the computer. Accordingly, the host device provides a read command to the handheld device, which is received via the host interface 18. The host interface 18 converts the read request into a generic format and provides the request to the processing module 20. The processing module 20 interprets the read request and coordinates the retrieval of the requested data from memory 16 via the memory interface 22. The retrieved data (e.g., Tx data) is provided to the host interface 18, which converts the format of the retrieved data from the generic format of the handheld device into the format of the coupling between the handheld device and the host device. The host interface 18 then provides the formatted data to the host device via the coupling.

The coupling between the host device and the handheld device may be a wireless connection or a wired connection. For instance, a wireless connection may be in accordance with Bluetooth, IEEE 802.11(a), (b) or (g), and/or any other wireless LAN (local area network) protocol, IrDA, etc. The wired connection may be in accordance with one or more Ethernet protocols, Firewire, USB, etc. Depending on the particular type of connection, the host interface module 18 includes a corresponding encoder and decoder. For example, when the handheld device 40 is coupled to the host device via a USB cable, the host interface module 18 includes a USB encoder and a USB decoder.

As one of average skill in the art will appreciate, the data stored in memory 16, which may have 64 Mbytes or of greater storage capacity, may be text files, presentation files, user profile information for access to varies computer services (e.g., Internet access, email, etc.), digital audio files (e.g., MP3 files, WMA—Windows Media Architecture-, MP3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format. As one of average skill in the art will further appreciate, when the handheld device 40 is coupled to the host device, the host device may power the handheld device 40 such that the battery is unused.

When the handheld device 40 is not coupled to the host device, the processing module 20 executes an algorithm 30 to detect the disconnection and to place the handheld device in a second operational mode. In the second operational mode, the processing module 20 retrieves, and subsequently executes, a second set of operational instructions from memory 16 to support the second operational mode. For example, the second operational mode may correspond to MP3 file playback, digital dictaphone recording, MPEG file playback, JPEG file playback, text messaging display, cellular telephone functionality, and/or AM/FM radio reception. Each of these functions is known in the art, thus no further discussion of the particular implementation of these functions will be provided except to further illustrate the concepts of the present invention.

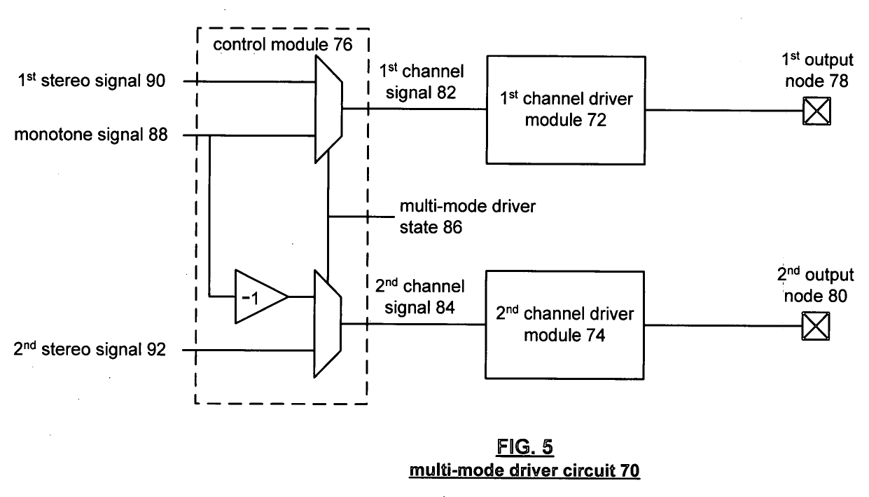

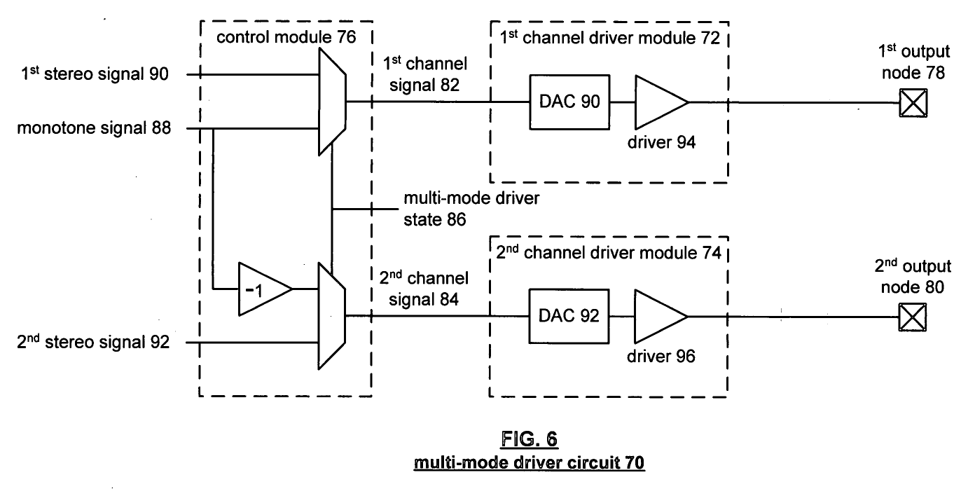

In the second operational mode, under the control of the processing module 20 executing the second set of operational instructions, the multimedia module 24 retrieves multimedia data 34 from memory 16. The multimedia data 34 includes at least one of digitized audio data, digital video data, and text data. Upon retrieval of the multimedia data, the multimedia module 24 converts the data 34 into rendered output data 36. For example, the multimedia module 24 may convert digitized data into audio signals and provides them to the multi-mode driver circuit 70. The multi-mode driver circuit 70, which will be described in greater detail with reference to FIGS. 5-9, processes the audio signals to produce analog signals and provides the analog signals a headphone jack 52, which may be coupled to a headphone 51 or to a speaker 52. In addition, or in the alternative, the multimedia module 24 may render digital video data and/or digital text data into RGB (red-green-blue), YUV, etc., data for display on an LCD (liquid crystal display) monitor, projection CRT, and/or on a plasma type display (e.g., display 48).

As further applications of the handheld device 40, the handheld device 40 may store digital information received via one of the multimedia input devices 44, 46, and 54 when in the first operational mode. For example, a voice recording received via the microphone 46 may be provided as multimedia input data 58, digitized via the multimedia module 24 and digitally stored in memory 16. Similarly, video recordings may be captured via the video capture device 44 (e.g., a digital camera, a camcorder, VCR output, DVD output, etc.) and processed by the multimedia module 24 for storage as digital video data in memory 16. Further, the key pad 54 (which may be a keyboard, touch screen interface, or other mechanism for inputting text information) provides text data to the multimedia module 24 for storage as digital text data in memory 16. In this extension of the first operational mode, the processing module 20 arbitrates write access to the memory 16 among the various input sources (e.g., the host and the multimedia module).

As even further applications of the handheld device 40, it may record and/or playback multimedia data stored in the memory 16 when in the second operational mode (i.e., not connected to the host). Note that the data provided by the host when the handheld device 40 was in the first operational mode includes the multimedia data. In this embodiment, depending on the type of multimedia data 34, the rendered output data 36 may be provided to one or more of the multimedia output devices. For example, rendered audio data may be provided to the headphone jack 52, while rendered video and/or text data may be provided to the display 48.

The handheld device 40 may also record multimedia data 34 while in the second operational mode. For example, the handheld device 40 may store digital information received via one of the multimedia input devices 44, 46, and 54.

As one of average skill in the art, the handheld device 40 may be packaged similarly to a thumb drive, a cellular telephone, pager (e.g., text messaging), a PDA, an MP3 player, a radio, and/or a digital dictaphone and offer the corresponding functions of multiple ones of the handheld devices (e.g., provide a combination of a thumb drive and MP3 player/recorder, a combination of a thumb drive, MP3 player/recorder, and a radio, a combination of a thumb drive, MP3 player/recorder, and a digital dictaphone, combination of a thumb drive, MP3 player/recorder, radio, digital dictaphone, and cellular telephone, etc.).

FIG. 5 is a schematic block diagram of an embodiment of a multi-mode driver circuit 70 that includes a first channel driver module 72, a second channel driver module 74, and a control module 76. In this illustrative embodiment, the control module 76 is shown to include two multiplexers and an inverter. These elements are illustrated to provide an example of the functionality of the control module 76, which may be implemented in a variety of ways to achieve the desired functionality. For example, the control module 76 may be incorporated in the processing module 20 and/or in the multimedia module 24.

In general, the multi-mode driver circuit 70 receives audio signals as stereo signals 90 and 92 or as a monotone signal 88, which may be a separately received signal or derived by mixing the stereo signals 90 and 92. The control module 76 functions to provide a first channel signal 82 to the first channel driver module 72 and to provide a second channel signal 84 to the second channel driver module 74 based on a multi-mode driver state 86.

When the multi-mode driver circuit 70 is in a first state 86, the control module 76 provides the monotone signal 88 as the first channel signal 82 to the first channel driver module 72 and an inversion of the monotone signal as the second channel signal 84 to the second channel driver module 74. The inversion of the monotone signal is achieved via the inverter, which may be an analog inverter or a digital inverter depending on whether the monotone signal 88 is an analog signal or a digital signal. When the multi-mode driver circuit 70 is in a second state 86, the control module 76 provides the first stereo signal 90 (e.g., a left channel signal) as the first channel signal 82 to the first channel driver module 72 and a second stereo signal 92 (e.g., a right channel signal) as the second channel signal 84 to the second channel driver module 74.

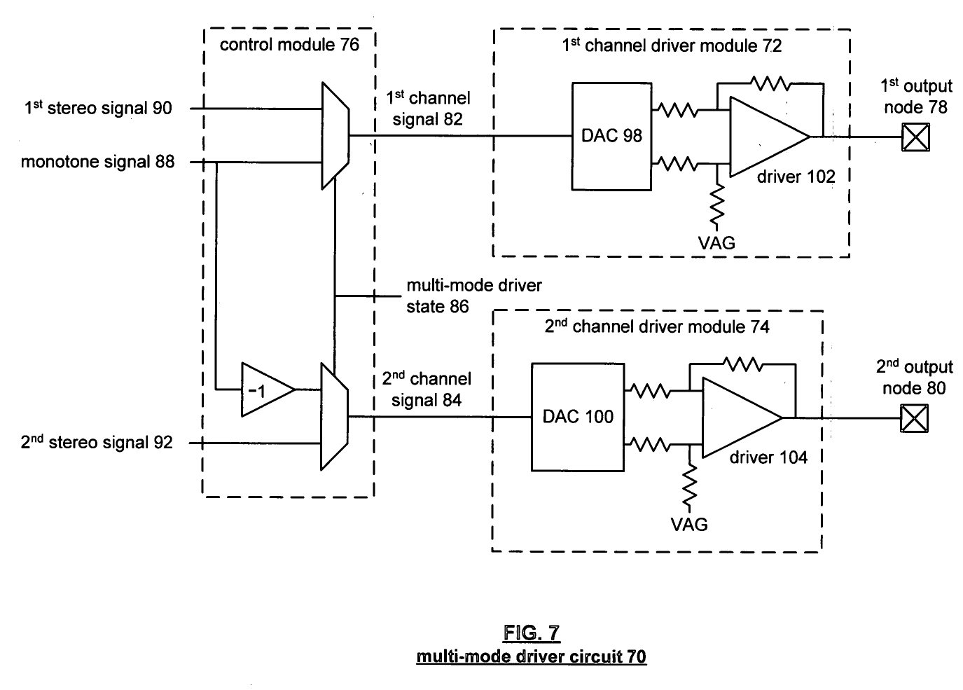

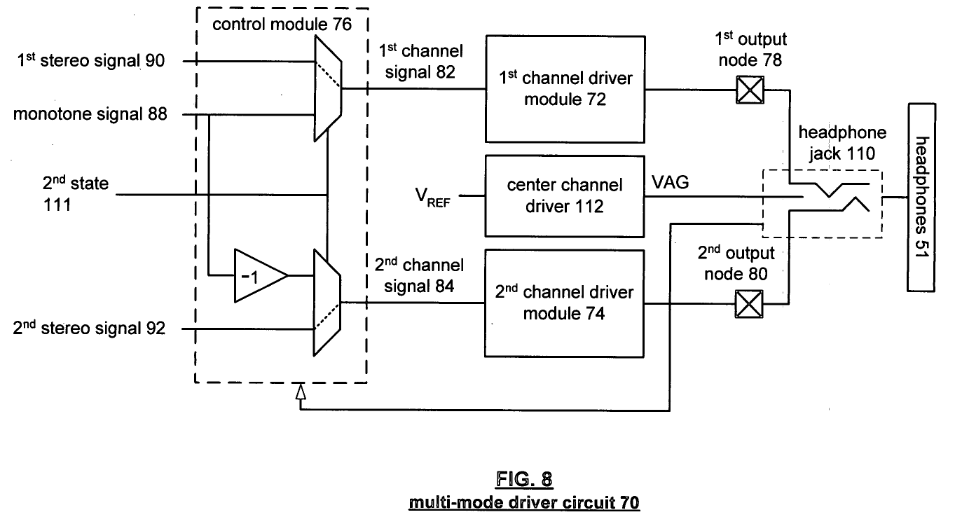

In either mode, the first channel driver module 72, which will be described in greater detail with reference to FIGS. 6 and 7, drives the first channel signal 82 to a first node 78 of an output and the second channel driver module 74, which will also be described in greater detail with reference to FIGS. 6 and 7, drives the second channel signal 84 to a second node 80 of the output. The first and second nodes 78 and 80 of the output may be a single output coupled to the headphone jack 52 or to the speaker 50. As one of ordinary skill in the art will appreciate, a speaker is typically driven with a differential monotone signal, while a headphone jack is driven with single-ended left and right channel signals with reference to an AC ground. The multi-mode driver circuit 70 provides a single driver circuit to drive the various requirements of speakers and headphone jacks.

FIG. 6 is a schematic block diagram of another embodiment of a multi-mode driver 70 that includes the control module 76, the first channel driver module 72, and the second channel driver module 74. The control module 76 functions as previously described with reference to FIG. 5 to provide the first channel signals 82 to the first channel driver module 72 and to provide the second channel signal 84 to the second channel driver module 74.

In this embodiment, each of the first and second channel driver modules 72 and 74 includes a digital to analog converter (DAC) 90 and 92 and a driver 94 and 96. Accordingly, the first and second channel signals 82 and 84 are digital signals, which are converted to analog signals via the DACs 90 and 92. The drivers 94 and 96, which may be unity gain amplifiers, drive the corresponding analog representation of the channel signal 82 and 84 to the corresponding output node 78 and 80.

FIG. 7 is a schematic block diagram of yet another embodiment of a multi-mode driver 70 that includes the control module 76, the first channel driver module 72, and the second channel driver module 74. The control module 76 functions as previously described with reference to FIG. 5 to provide the first channel signals 82 to the first channel driver module 72 and to provide the second channel signal 84 to the second channel driver module 74.

In this embodiment, each of the first and second channel driver modules 72 and 74 includes a differential digital to analog converter (DAC) 98 and 100 and a differential to single-ended driver 102 and 104. Each of the single-ended drivers 102 and 104 includes an amplifier and a plurality of resistors coupled as shown. The value of the resistors depends on the desired gain of the driver 102 and 104 and on power consumption requirements. As one of ordinary skill in the art will appreciate, there are numerous ways to implement a differential to single-ended driver including the one presented in this figure.

The differential DACs 98 and 100 convert the respective channel signals 82 and 84 into differential analog signals. The drivers 102 and 104 convert the differential analog signals into single-ended signals and drive them to the corresponding output node 78 and 80.

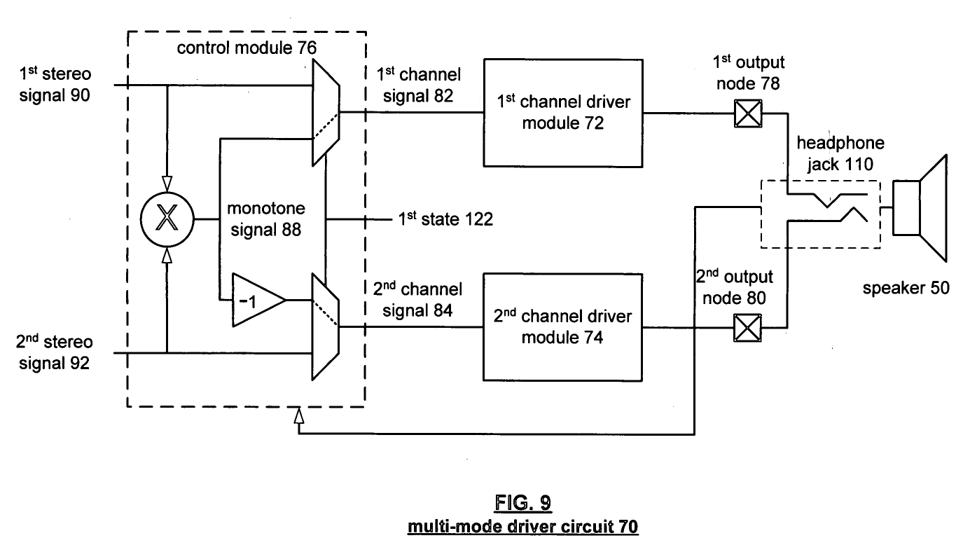

FIG. 8 is a schematic block diagram of a further embodiment of a multi-mode driver 70 operational in a second state 111 of the multi-mode driver state 86 and coupled to a headphone jack 110, which is coupled to a headphone 51. In this embodiment, the control module 76 monitors the load on the first and second nodes 78 and 80 of the output. When, as in this example, the output nodes are coupled to a headphone jack, the control module 76 senses the output connection and places the driver 70 in the second state 111. As one of ordinary skill in the art will appreciate, there are a variety of ways in which the control module 76 can sense the output connection and determine the load connected thereto. For example, the control module 76 may determine the impedance of the load and, via a look up table, determine the type of load. Or the control module 76 may use the switch state of a special headphone jack that includes a switch to determine if the headphone is plugged in (reword as necessary, this is the more likely method to be used).

The multi-mode driver 70 is further shown to include a center channel driver 112 that produces an AC ground voltage (VAC) from a reference voltage (VREF). The center channel driver 112 provides the AC ground voltage to a ground connection of the headphone jack 110 and a DC bias to avoid the need for DC blocking caps in the headphone load. A left channel connection of the headphone jack 110 receives the signal driven by the first channel driver module 72 and a right channel connection of the headphone jack 110 receives the signal driven by the second channel driver module 74. In this mode, the control module 76 provides the first stereo signal 90 to the first channel driver module 72 and the second stereo signal 92 to the second channel driver module 74.

FIG. 9 is a schematic block diagram of a still further embodiment of a multi-mode driver 70 operational in a first state 122 of the multi-mode driver state 86 and coupled to the headphone jack 110, which is coupled to a speaker 50. In this embodiment, the control module 76 monitors the load on the first and second nodes 78 and 80 of the output, the state of the headphone jack, or a combination thereof. When, as in this example, the output nodes are coupled to a speaker, the control module 76 senses the output connection and places the driver 70 in the first state 122. As one of ordinary skill in the art will appreciate, there are a variety of ways in which the control module 76 can sense the output connection and determine the load connected thereto. For example, the control module 76 may determine the impedance of the load and, via a look up table, determine the type of load.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The preceding discussion has presented a multi-mode driver circuit that is capable of automatic configuration based on the load coupled thereto. As one of ordinary skill in the art will appreciate, other embodiments may be derived from the teachings of the present invention without deviating from the scope of the claims.

What is claimed is:

1. A multi-mode driver circuit comprises:
a first channel driver module operably coupled to drive a first channel signal to a first node of an output;
a second channel driver module operably coupled to drive a second channel signal to a second node of the output;
control module operably coupled to:
provide a monotone signal as the first channel signal to the first channel driver module and an inversion of the monotone signal as the second channel signal to the second channel driver module when the multi-mode driver is in a first state; and
provide a first stereo signal as the first channel signal to the first channel driver module and a second stereo signal as the second channel signal to the second channel driver module when the multi-mode driver is in a second state.

2. The multi-mode driver circuit of claim 1, wherein the first channel driver module comprises:
a first digital to analog converter operably coupled to convert a digital representation of the first channel signal into an analog representation of the first channel signal, and
a first driver operably coupled to drive the analog representation of the first channel signal.

3. The multi-mode driver circuit of claim 2, wherein the second channel driver module comprises:
a second digital to analog converter operably coupled to convert a digital representation of the second channel signal into an analog representation of the second channel signal; and
a second driver operably coupled to drive the analog representation of the second channel signal.

4. The multi-mode driver circuit of claim 3 comprises:
the first and second digital to analog converters producing a differential analog representation of the first and second channel signals, respectively; and
the first and second drivers having a differential input and a single-ended output.

5. The multi-mode driver circuit of claim 1, wherein the control module further functions to:
detect coupling of a headphone jack to the first and second nodes of the output;
when the coupling of the headphone jack to the first and second nodes of the output is detected, place the multi-mode driver in the second state; and
when the coupling of the headphone-jack to the first and second nodes of the output is not detected, place the multi-mode driver in the first state.

6. The multi-mode driver circuit of claim 1, wherein the control module further functions to:
receive a left channel signal;
receive a right channel signal; and
mix the left and right channel signals to produce the monotone signal.

7. The multi-mode driver circuit of claim 1 further comprises:
a center channel driver module operably coupled to drive a reference potential for the first and second nodes of the output when the multi-mode driver circuit is in the second state and to provide a high impedance output when the multi-mode driver circuit is in the first mode.

8. A multi-mode driver circuit comprises:
a first channel driver module operably coupled to drive a first channel signal to a first node of an output;
a second channel driver module operably coupled to drive a second channel signal to a second node of the output;
control module operably coupled to:
detect coupling of a headphone jack to the first and second nodes of the output;
when the coupling of the headphone jack to the first and second nodes of the output is detected, provide a monotone signal as the first channel signal to the first channel driver module and an inversion of the monotone signal as the second channel signal to the second channel driver module; and
when the coupling of the headphone jack to the first and second nodes of the output is not detected, provide a first stereo signal as the first channel signal to the first channel driver module and a second stereo signal as the second channel signal to the second channel driver module.

9. The multi-mode driver circuit of claim 8, wherein each of the first and second channel driver modules comprises:
a digital to analog converter operably coupled to convert a digital representation of the first or second channel signal into an analog representation of the first or second channel signal; and
a driver operably coupled to drive the analog representation of the first or second channel signal.

10. The multi-mode driver circuit of claim 8, wherein the control module further functions to:
receive a left channel signal;
receive a right channel signal; and
mix the left and right channel signals to produce the monotone signal.

11. The multi-mode driver circuit of claim 1 further comprises:
a center channel driver module operably coupled to drive a reference potential for the first and second nodes of the output when the multi-mode driver circuit is in the second state and to provide a high impedance output when the multi-mode driver circuit is in the first mode.

12. A multi-mode driver circuit comprises:
a first channel driver module operably coupled to drive a first channel signal to a first node of an output;
a second channel driver module operably coupled to drive a second channel signal to a second node of the output;
control module operably coupled to:
receive a left channel signal and a right channel signal;
determine whether the multi-mode driver circuit is in a first state or a second state;
when the multi-mode driver circuit is in the first state:
mix the left and right channel signals to produce a monotone signal;
provide the monotone signal as the first channel signal to the first channel driver module and an inversion of the monotone signal as the second channel signal to the second channel driver module; and
when the multi-mode driver circuit is in the second state, provide the left channel signal as the first channel signal to the first channel driver module and the right channel signal as the second channel signal to the second channel driver module.

13. The multi-mode driver circuit of claim 12, wherein each of the first and second channel driver modules comprises:
a digital to analog converter operably coupled to convert a digital representation of the first or second channel signal into an analog representation of the first or second channel signal; and
a driver operably coupled to drive the analog representation of the first or second channel signal.

14. The multi-mode driver circuit of claim 12, wherein the control module further functions to determine whether the multi-mode driver circuit is in the first state or the second state by:
detecting coupling of a headphone jack to the first and second nodes of the output;
when the coupling of the headphone jack to the first and second nodes of the output is detected, determining that the multi-mode driver is in the second state; and
when the coupling of the headphone jack to the first and second nodes of the output is not detected, determining that the multi-mode driver in the first state.

15. The multi-mode driver circuit of claim 12 further comprises:
a center channel driver module operably coupled to drive a reference potential for the first and second nodes of the output when the multi-mode driver circuit is in the second state and to provide a high impedance output when the multi-mode driver circuit is in the first mode.

16. An audio processing integrated circuit comprises:
a processing module;
memory operably coupled to the processing module, wherein the memory at least temporarily stores operational instructions that cause the processing module to process digital audio signals; and
a multi-mode driver circuit that includes:
a first channel driver module operably coupled to drive a first channel signal to a first node of an output; and
a second channel driver module operably coupled to drive a second channel signal to a second node of the output, wherein the memory further at least temporarily stores operational instructions that cause the processing module to:
provide a monotone signal as the first channel signal to the first channel driver module and an inversion of the monotone signal as the second channel signal to the second channel driver module when the multi-mode driver is in a first state; and
provide a first stereo signal as the first channel signal to the first channel driver module and a second stereo signal as the second channel signal to the second channel driver module when the multi-mode driver is in a second state.

17. The audio processing integrated circuit of claim 16, wherein each of the first and second channel driver modules comprises:
a digital to analog converter operably coupled to convert a digital representation of the first or second channel signal into an analog representation of the first or second channel signal; and
a driver operably coupled to drive the analog representation of the first or second channel signal.

18. The audio processing integrated circuit of claim 16, wherein the memory further at least temporarily stores operational instructions that cause the processing module to:
detect coupling of a headphone jack to the first and second nodes of the output;
when the coupling of the headphone jack to the first and second nodes of the output is detected, place the multi-mode driver in the second state; and
when the coupling of the headphone jack to the first and second nodes of the output is not detected, place the multi-mode driver in the first state.

19. The audio processing integrated circuit of claim 16, wherein the memory further at least temporarily stores operational instructions that cause the processing module to:
receive a left channel signal;
receive a right channel signal; and
mix the left and right channel signals to produce the monotone signal.

20. The audio processing integrated circuit of claim 16, wherein the multi-mode driver circuit further comprises:
a center channel driver module operably coupled to drive a reference potential for the first and second nodes of the output when the multi-mode driver circuit is in the second state and to provide a high impedance output when the multi-mode driver circuit is in the first mode.
